(19) United States
(12) Patent Application Publication
(10) Pub. No.: US 2004/0164187 A1
(43) Pub. Date: Aug. 26, 2004

(54) Fuel injection valve

(75) Inventors: Yusuke Kihara, Hitachi (JP); Yoshihiro Sukegawa, Hitachi (JP); Toshiharu Nogi, Hitachinaka (JP); Masahiro Souma, Hitachi (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd.

(21) Appl. No.: 10/761,324

(22) Filed: Jan. 22, 2004

(30) Foreign Application Priority Data
Jan. 22, 2003 (JP) 2003-013581

(51) Int. Cl. B05B 1/14

(52) U.S. Cl. 239/552; 239/584; 239/596

(57) ABSTRACT

The flow rate distribution of the fuel injected from the injection port which passes the section at a specific position of the downstream from the injection port of fuel injector has the characteristic that when the point that the periphery of the fuel spray close to the central axis of the injection port intersects with straight line L that connects respective gravities of the fuel sprays injected in two directions is assumed to be first point P1, the point that the periphery of the fuel spray far from the central axis intersects with straight line L second point P2, and the point in the middle of first point P1 and second point P2 third point P3, the peak position of flow rate on straight line L exists between first point P1 and third point P3, and the flow rate decreases with getting away from peak position on straight line L.

### BACKGROUND OF THE INVENTION

The present invention relates to a fuel injection valve or fuel injector. Especially, the present invention relates to a fuel injector arranged in an intake pipe of a port injection type internal combustion engine, which can decrease unburnt hydrocarbon (HC) by generating a specific fuel spray form.

The port injection type internal combustion engine usually used in which the fuel injector is arranged in the intake pipe injects the fuel in the direction of intake valve in a combustion chamber by the fuel injector. The promotion of evaporation is worsened because of the decrease of the surface area when the injected fuel adheres to the wall surface of the intake pipe. As a result, there is a problem that the time required for the fuel to enter in the combustion chamber delays, and the response of the internal combustion engine deteriorates.

Moreover, because the fuel is diluted with the engine oil, evaporation becomes insufficient when the fuel which adheres to the intake pipe is carried away along the wall surface to flow in the combustion chamber as the liquid film. As a result, it is likely to be exhausted from the internal combustion engine as unburnt hydrocarbon. Especially, said unburnt hydrocarbon is emitted to air as it is without purifying in the operation area within the period of tens of seconds after start-up, in which the three-way catalyst has not been activated yet when the three way catalyst is arranged in the exhaust pipe of the internal combustion engine. As a result, there is a problem on the deterioration of the environment.

The technology to solve said problems is disclosed in Japanese Patent Application Laid-Open No. 8-218986. In the technology, the injection port of the fuel injector arranged in the intake pipe is formed to the shape of a substantial curved semicircular arc or V character. Further, the fuel spray pattern of the fuel injected from the injection port of the fuel injector is formed to the shape of the substantial circular arc or V character, etc., and the fuel spray is directed to collide with the back of intake valve. As a result, the adhesion of the fuel to the intake pipe is decreased, and the fuel spray is diffused over the back surface of intake valve (umbrella portion). As a result, the transportation delay of the fuel decreases, the acceleration performance improves, and the exhaust emission decreases.

By the way, the intake valve is in the state of a low lift at an initial stage of the suction stroke of the internal combustion engine. A high-speed airflow is generated in the back of intake valve (umbrella portion) because the opening space of the intake valve is small when intake valve is in the state of the low lift. In this case, the fuel which adheres to the back of intake valve is torn off from the edge of intake valve (umbrella portion) by said high-speed airflow, and enters in the cylinder. However, when the fuel is torn off from the liquid film, the fuel is made minute grain by shearing force with a high-speed airflow because the flow velocity of the airflow gets to the vicinity of speed of sound.

However, the fuel has concentrated on the umbrella portion of the fuel injector side of the intake valve (back of the intake valve) in the technology disclosed in said Japanese Patent Application Laid-Open No. 8-218986. Therefore, the fuel liquid film formed to the back of intake valve is thick, and the diameter of the fuel droplet made minute grain by a high-speed airflow increases. Further, the fuel adheres easily to the cylinder bore wall by the inertia of the fuel droplet because the distance from the edge of the intake valve of the fuel injector side (outside edge) to the cylinder bore wall is short. Therefore, it is expected that the fuel is diluted with the engine oil, and the evaporation becomes difficult. As a result, it is likely to produce a factor that unburnt hydrocarbon is generated.

### SUMMARY OF THE INVENTION

The present invention is made in consideration of the above-mentioned problems.

An object of the present invention is to provide a fuel injector for a port injection type internal combustion engine which has the specific fuel spray form by which the amount of the fuel adhesion to the cylinder bore wall decreases greatly when the fuel which adheres to the back of intake valve is blown off from the edge of the intake valve by the airflow.

To achieve the above-mentioned object, a fuel injector according to the present invention basically is arranged in the intake pipe of a port injection type internal combustion engine, which the fuel is injected from the injection port in two directions. The flow rate distribution of the fuel injected from the injection port which passes the section at a specific position of the downstream from the injection port of said fuel injector has the characteristic that when the point that the periphery of the fuel spray close to the central axis of the injection port intersects with straight line L that connects respective gravities of the fuel sprays injected in two directions is assumed to be first point P1, the point that the periphery of the fuel spray far from the central axis intersects with said straight line L is assumed to be second point P2, and the point in the middle of the first point P1 and the second point P2 is assumed to be third point P3, the peak position of flow rate on said straight line L exists between said first point P1 and said third point P3, and the flow rate decreases with getting away from said peak position on said straight line L.

Preferably, the specific position of the downstream from said injection port is at downstream 100 mm of said injection port.

Further preferably, the flow rate distribution of the fuel spray injected in said two directions is almost symmetry, and integral value of the flow rate of said third point P3 from said first point P1 is 1.5 times or more as much as integral value of the flow rate of said third point P3 from said second point P2.

It is possible to increase the flow rate distribution at the inside of the fuel spray and decrease the distribution at the outside when the fuel is sprayed in two directions from the injection port in the fuel injector of the present invention configured as mentioned above. As a result, the thickness of the liquid film outside of intake valve is thinned, the thickness of the liquid film inside of intake valve is thickened, and the fuel adhesion to the cylinder bore wall is prevented, and the unburnt hydrocarbon can be decreased.

Moreover, in another embodiment of the fuel injector of the present invention, a fuel injector is arranged in the intake pipe of a port injection type internal combustion engine, which the fuel is injected from the injection port in two directions. When the flow rate distribution of the fuel spray which passes the section at a specific position of the downstream from said injection port is divided into a plurality of regions in a direction which extends from the inside of the fuel spray injected in two directions to the outside, the flow rate of each region in a direction perpendicular to said direction is integrated, and when the point inside of the fuel spray is assumed to be first point P1, the point outside of the fuel spray is assumed to be second point P2 and the point in the middle of said first point P1 and said second point P2 is assumed to be third point P3, the peak position of said flow rate integral value exists between said first point P1 and said third point P3 and the flow rate integralvalue decreases as the position gets away from the peak position.

Preferably, the specific position of the downstream from said injection port is at downstream 100 mm of said injection port.

Further preferably, the flow rate distribution of the fuel spray injected in said two directions is almost symmetry, and integral value of the flow rate of said third point P3 from said first point P1 is 1.5 times or more as much as integral value of the flow rate of said third point P3 from said second point P2.

It can be expected that the fuel injector of the present invention configured as mentioned above has the same effect as said primary invention.

According to a further embodiment of the fuel injector of the present invention, a fuel injector is arranged in the intake pipe of a port injection type internal combustion engine, which the fuel is injected from the injection port in two directions. The injection port is terebrated in an axial direction inclined with respect to a center axis of said fuel injector, and when the center axis is assumed to be Z axis, the direction where the fuel spray of two directions extends is assumed to be X axis and the axis perpendicular to an X-Y plane is assumed to be Y axis, the tilt angle θ of said injection port becomes large and the diameter of said injection port becomes small, as the distance S from a Y-Z plane increases.

In the fuel injector of the present invention configured as mentioned above, when the fuel is injected from the fuel injector in the exhaust stroke of the internal combustion engine, the fuel sprays directed to two directions are produced because the injection ports of the nozzle are terebrated to +direction and −direction respectively with respect to the X-axis. The larger the diameter of the injection ports, the more the amount of the fuel injected increases. The flow rate distribution of this fuel spray increases in the inside, but decreases with shifting to the outside. The peak position of the fuel distribution exists on the inside from the stem of the intake valve. When the injected fuel adheres to the umbrella portion of the intake valve, the fuel liquid film formed on the umbrella portion outside of the stem of the intake valve becomes thin compared with the inside.

In a further embodiment of the fuel injector of the present invention, a fuel injector is arranged in the intake pipe of a port injection type internal combustion engine, which the fuel is injected from the injection port in two directions, wherein said injection port is terebrated in an axial direction inclined with respect to a center axis of said fuel injector, and when the center axis is assumed to be Z axis, the direction where the fuel spray of two directions extends is assumed to be X axis, and the axis perpendicular to an X-Y plane is assumed to be Y axis, The tilt angle θ of said injection port becomes large and the number of said injection port becomes small as the distance S from a Y-Z plane increases.

In the fuel injector of the present invention configured as mentioned above, when the fuel is injected from the fuel injector in the exhaust stroke of the internal combustion engine, the fuel sprays directed to two directions are produced because the injection ports of the nozzle are terebrated to + direction and − direction respectively with respect to the X-axis. The more the number of the injection ports, the more the amount of the fuel injected increases. The flow rate distribution of this fuel spray increases in the inside, but decreases with shifting to the outside. The peak position of the fuel distribution exists on the inside from the stem of the intake valve. When the injected fuel adheres to the umbrella portion of the intake valve, the fuel liquid film formed on the umbrella portion outside of the stem of the intake valve becomes thin compared with the inside.

### BRIEF DESCRIPTION OF DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a longitudinal sectional view of the internal combustion engine where the fuel injector according to a first embodiment of the present invention is arranged.

FIG. 2 is a cross sectional view of the top part of the internal combustion engine according to the embodiment shown in FIG. 1, shown in a schematic form.

FIG. 3 is a longitudinal sectional view of the nozzle of the fuel injector according to the embodiment shown in FIG. 1.

FIG. 4 is a view showing a porous plate in the nozzle of the fuel injector shown in FIG. 3.

FIG. 5A and FIG. 5B show the states of the fuel sprays injected by the fuel injector according to the embodiment shown in FIG. 1. Where, FIG. 5A shows the flow rate distribution of fuel spray F. FIG. 5B shows the flow rate distribution of fuel spray F in section A-A of FIG. 5A.

FIG. 6 is a longitudinal sectional view of the nozzle of the fuel injector according to a second embodiment of the present invention.

FIG. 7 is a view showing a porous plate in the nozzle of the fuel injector shown in FIG. 6.

FIG. 8A and FIG. 8B show the states of the fuel sprays injected by the fuel injector according to the second embodiment shown in FIG. 6. Where, FIG. 8A shows the flow rate distribution of fuel spray F. FIG. 8B shows the flow rate distribution of fuel spray F in section A-A of FIG. 8A.

### DETAILED DESCRIPTION OF THE PREFERRED EMBODIMENTS

The present invention will be discussed hereinafter in detail in terms of the preferred embodiment of a fuel injector according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

Hereafter, two embodiments of the fuel injector of the present invention are explained in detail based on the drawings.

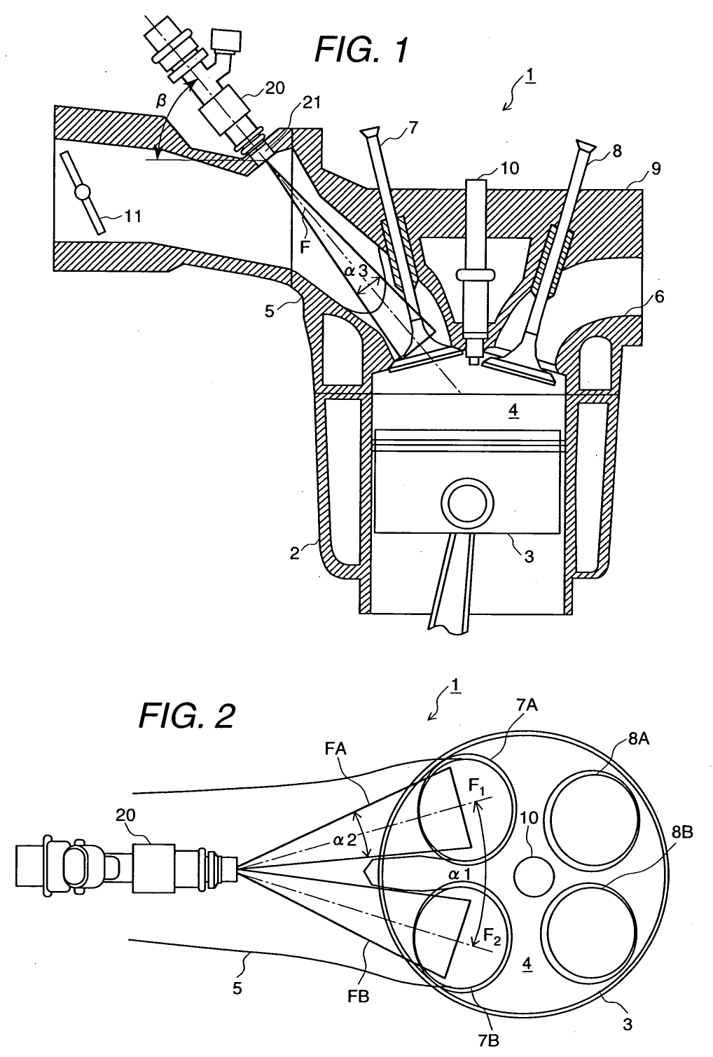

FIG. 1 and FIG. 2 show an internal combustion engine used in common for two embodiments of the present invention. FIG. 1 is a longitudinal sectional view of the internal combustion engine. FIG. 2 is a cross sectional view of the top part of the internal combustion engine, shown in a schematic form.

Said internal combustion engine 1 comprises cylinder block 2, cylinder head 9, and piston 3 inserted in said cylinder block 2. Combustion chamber 4 is formed in said cylinder block 2. Intake pipe 5 and exhaust pipe 6 formed in cylinder head 9 are opened to combustion chamber 4. Two intake valves 7A, 7B for opening and shutting the opening portion and two exhaust valves 8A, and 8B are arranged in cylinder head 9. Throttle valve 11 for adjusting the amount of the air inhaled into combustion chamber 4 and fuel injector 2 according to this embodiment are arranged in the upstream of intake pipe 5. The fuel injector 20 is arranged at the position where it is possible to inject the fuel aiming at intake valves 7A and 7B. Moreover, sparking plug 10 is provided on the center part of combustion chamber 4.

Fuel spray F injected from nozzle 21 of fuel injector 20 is divided into two directions. One fuel spray FA is directed in the direction of intake valve 7A, and the other fuel spray FB in the direction of intake valve 7B respectively. When the fuel spray central lines F1 and F2 each of which divides spray angle α2 into two are extended, the inclination angle β of fuel injector 20 and intersection angle α1 of fuel spray central lines F1 and F2 are decided so that central lines F1 and F2 of the fuel sprays may be located at the centers of the umbrella portions of intake valves 7A and 7B respectively.

Moreover, spray angles α2 and α3 are decided respectively so that neither fuel spray FA nor FB may hit the inner wall of intake pipe 5.

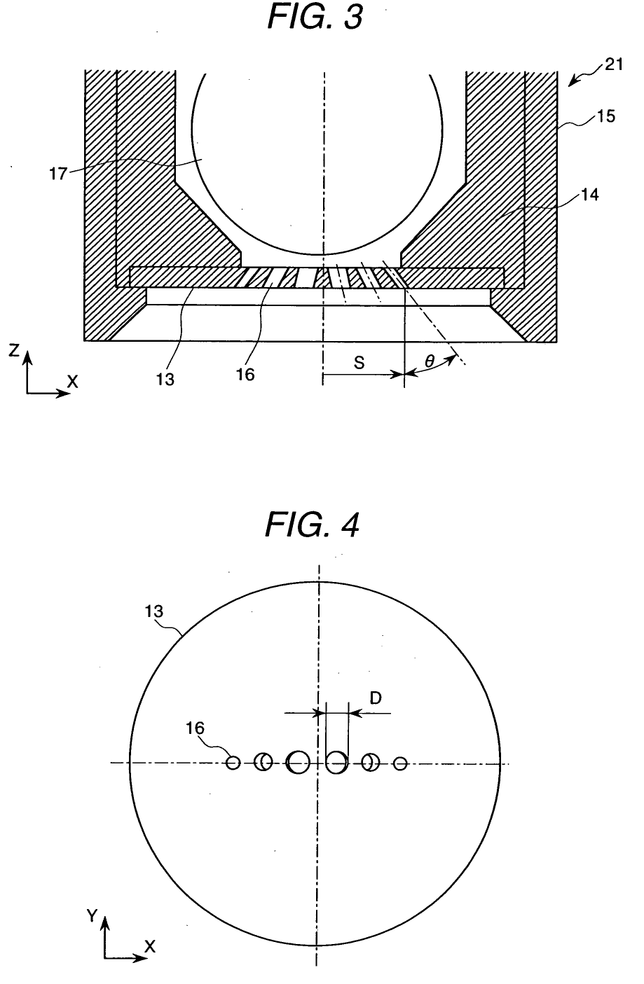

FIG. 3 and FIG. 4 show the configuration of nozzle 21 of fuel injector 20 according to the first embodiment of the present invention. FIG. 3 shows a longitudinal sectional view of nozzle 21 which passes the center of fuel injector 20.

FIG. 4 is a view seen from the head side of nozzle 21 of fuel injector 20.

In nozzle 21 at the head of fuel injector 20 according to this embodiment, porous plate 13 is fixed to valving element 15 by guide 14. Two or more injection ports 16 are terebrated to porous plate 13. Ball valve 17 is provided to move up and down. The fuel flows in the space between guide 14 and ball valve 17 by ball valve's rising, and flows in injection port 16.

Injection port 16 is terebrated in the direction of the axis which inclines with respect to the center axis of fuel injector 20. In FIG. 3 and FIG. 4, the tilt angle θ of the injection port becomes larger by increasing distance S from the plane which consists of Y axis and Z axis when X axis, Y axis, and Z axis are defined. The angle θ is decided within the range in which fuel spray FA and FB generated does not adhere to intake pipe 5.

Moreover, injection port 16 is provided on the X axis which passes the center axis of fuel injector 20.

Diameter D becomes smaller by increasing distance S from the plane which consists of Y axis and Z axis

Porous plate 13 is provided at the head of fuel injector 20 so that X axis may become parallel to the piston pin.

In the fuel injector 20 of the present invention configured as mentioned above, when the fuel is injected from the fuel injector 20 in the exhaust stroke of the internal combustion engine, the fuel sprays directed to two directions are produced because the injection ports 16 of the nozzle are terebrated to + direction and − direction respectively with respect to the X-axis. The larger the diameter of the injection ports, the more the amount of the fuel injected increases. The flow rate distribution of this fuel spray increases in the inside, but decreases with shifting to the outside. The peak position of the fuel distribution exists on the inside from the stem of the intake valve 7. When the injected fuel adheres to the umbrella portion of the intake valve 7, the fuel liquid film formed on the umbrella portion outside of the stem of the intake valve 7 becomes thin compared with the inside.

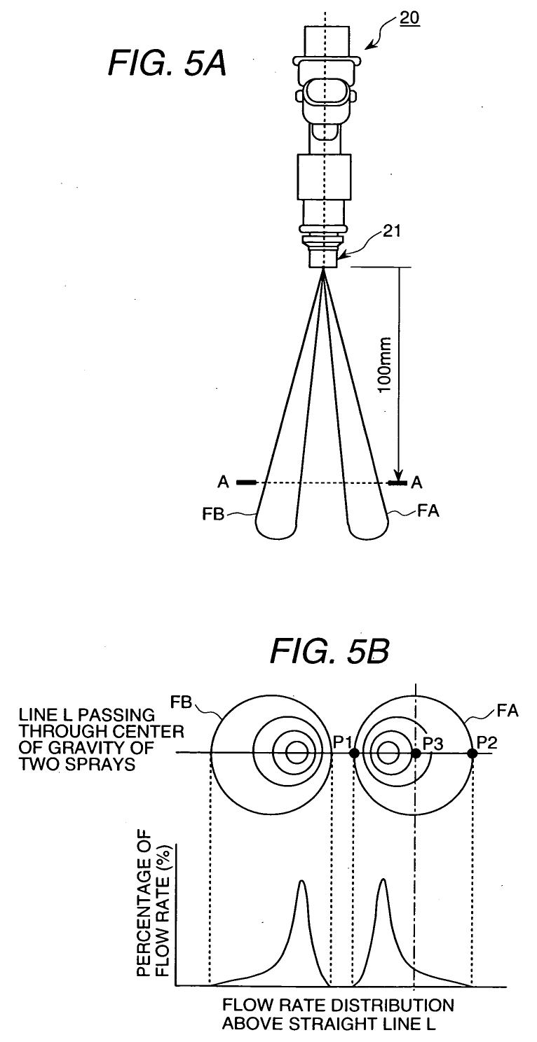

FIG. 5A and FIG. 5B show one example of the state of the fuel spray when the fuel is injected by using fuel injector 20 according to this embodiment. The flow rate distributions of fuel sprays FA and FB shown in FIG. 5B indicate the flow rate ratio when the injected fuel passes A-A section of 100 mm under the nozzle shown in FIG. 5A. The flow rate distributions of fuel sprays FA and FB is almost symmetry as shown in FIG. 5B.

When the points that the peripheries of the fuel sprays FA, FB close to the central axis of the injection port intersect with straight line L that connects respective gravities of the fuel sprays injected in two directions are assumed to be first points P1, the points that the peripheries of the fuel sprays FA, FB far from the central axis intersect with said straight line L are assumed to be second points P2, and the points in the middle of the first points P1 and the second points P2 are assumed to be third points P3, the peak positions of flow rate on said straight line L exist between said first points P1 and said third points P3, and the flow rate decreases with getting away from said peak position on said straight line L. The flow rate of the third point P3 from first point P1 is 1.5 times or more as much as the flow rate of the third point P3 from the second point P2.

Next, the state when an internal combustion engine which uses fuel injector 20 according to this embodiment works is explained. In operating conditions, the engine speed immediately after start-up is in low load operation of 1200 rpm. Because the amount of fuel injection is small, the opening of throttle valve 11 is reduced so that the intake airflow may decrease to match the air-fuel ratio to about 15 which is theoretical mixture ratio of gasoline.

The fuel is injected during the exhaust stroke. Injection of fuel is begun at the time the fuel combustion is completed and before intake valve 7 opens at least. Because there is little airflow in intake pipe 5 when the fuel is injected according to this timing, fuel spray F almost adheres to the umbrella portion of intake valve 7 without making turbulence, and forms the liquid film. The fuel liquid film formed outside of the stem of intake valve 7 becomes thin compared with one of the inside, because the flow rate in the inside of fuel spray F increases as mentioned above for the flow rate distribution.

When the operation enters the suction stroke, and intake valve 7 begins to open, Intake pipe 5 is at a negative pressure because throttle valve 11 has been shut though the combustion gas of the slightly higher pressure than the atmospheric pressure is filled in combustion chamber 4. Therefore, the backflow is caused from combustion chamber 4 to intake pipe 5 first. At this time, the burnt gas does not adhere for a high temperature of about 1000 K. The fuel which drifts in air is easy to evaporate, and the fuel which could not be evaporated enters combustion chamber 4 later.

The pressure of combustion chamber 4 drops compared with intake pipe 5 by piston's descending, and air is inhaled. The inflow area is small in the condition with a little amount of the lift of intake valve 7 at the beginning of the suction stroke. Therefore, a high-speed airflow is caused. The flow velocity of the airflow gets to the vicinity of speed of sound in the maximum though it is different depending on the specification of displacement volume etc. occasionally.

The fuel which adheres to the back of the umbrella portion of intake valve 7 is made to minute grain by tearing off from the edge of the umbrella portion of intake valve 7 by shearing force with said airflow, and enters combustion chamber 4. The distance from the umbrella portion in the outside of intake valve 7 to the cylinder bore wall is shorter, and the fuel torn off from the edge of the umbrella portion of intake valve 7 adheres easily to the cylinder bore wall by inertia when the distances from the edge of the umbrella portion in the outside of intake valve 7 to the bore wall of cylinder 2 and the distances from the edge of the umbrella portion in the inside of intake valve 7 to the bore wall of cylinder 2 are compared.

However, the thickness of the liquid film of the umbrella portion in the outside of intake valve 7 has made thin by controlling the flow rate distribution of the fuel spray in the fuel injector according to this embodiment. The diameter of the droplet torn off from the liquid film and made minute grain is small. Therefore, the inertia force is weak, and the droplet is carried away along with the airflow.

As a result, the amount of the adhesion to the cylinder bore wall is little.

Moreover, the thickness of the liquid film of the umbrella portion in the inside of intake valve 7 is thicker than the thickness of the liquid film generated when the flow rate ratio in the inside and the outside of intake valve 7 is uniform. However, because the distance from the umbrella portion of the inside of intake valve 7 to the cylinder bore wall is long, the inertia force of the droplets torn off from the edge of intake valve 7 and blown off attenuates and carries away along with the airflow. Therefore, they do not adhere to the cylinder bore wall.

Thus, when the fuel injector of this embodiment is used, the fuel evaporates easily and unburnt hydrocarbon is decreased because the fuel adhesion to the intake pipe and the cylinder bore wall is little.

Next, the fuel injector according to a second embodiment of the present invention is explained.

The configuration of the internal combustion engine for which the fuel injector according to this embodiment is used is the same as the first embodiment.

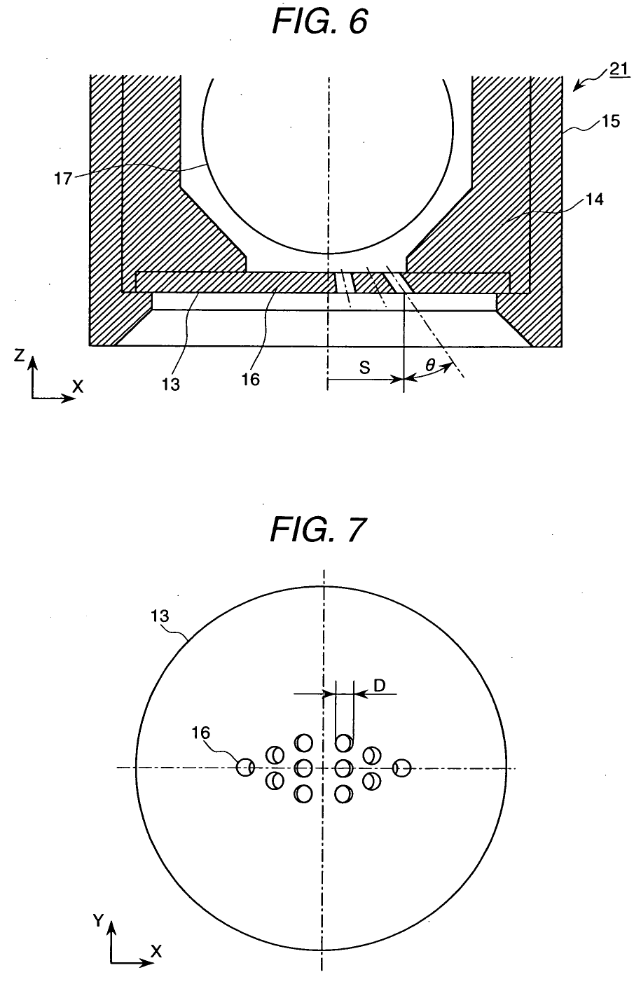

FIG. 6 and FIG. 7 show the structure of nozzle 21 of fuel injector 20 according to the second embodiment of the present invention. FIG. 6 shows a longitudinal sectional view of nozzle 21 which passes the center of fuel injector 20. FIG. 7 is a view seen from the head side of nozzle 21 of fuel injector 20.

In nozzle 21 at the head of fuel injector 20, porous plate 13 is fixed to valving element 15 by guide 14. Two or more injection ports 16 are terebrated to porous plate 13. Ball valve 17 is provided to move up and down. The fuel flows in the space between guide 14 and ball valve 17 by ball valve's rising, and flows in injection port 16.

Injection port 16 is terebrated in the direction of the axis which inclines with respect to the center axis of fuel injector 20. In FIG. 6 and FIG. 7, the tilt angle θ of the injection port becomes larger by increasing distance S from the plane which consists of Y axis and Z axis when X axis, Y axis, and Z axis are defined. The angle θ is decided within the range in which fuel spray FA and FB generated does not adhere to intake pipe 5.

All injection ports 16 almost have the same diameter. The number of the fuel ports included in the group becomes smaller with increasing distance S from the plane which consists of Y axis and Z axis. Porous plate 13 is provided at the head of fuel injector 20 so that X axis may become parallel to the piston pin.

In the fuel injector 20 according to this embodiment, when the fuel is injected from the fuel injector 20 in the exhaust stroke of the internal combustion engine, the fuel sprays directed to two directions are produced because the injection ports 16 of the nozzle are terebrated to +direction and −direction respectively with respect to the X-axis. The more the number of the injection ports 16 included in each group, the more the amount of the fuel injected increases. The flow rate distribution of this fuel spray increases in the inside, but decreases with shifting to the outside. The peak position of the fuel distribution exists on the inside from the stem of the intake valve 7. When the injected fuel adheres to the umbrella portion of the intake valve 7, the fuel liquid film formed on the umbrella portion outside of the stem of the intake valve 7 becomes thin compared with the inside. It is, therefore, possible to obtain the same effects as the first embodiment.

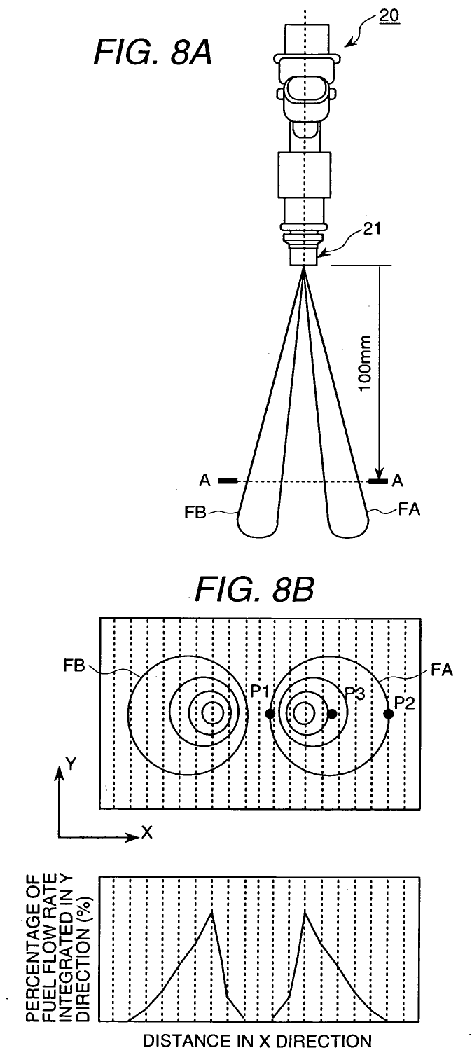

FIG. 8A and FIG. 8B show one example of the state of the fuel spray when the fuel is injected by using fuel injector 20 according to this embodiment.

The flow rate distributions of fuel sprays FA and FB shown in FIG. 8B indicate the flow rate ratio when the injected fuel passes A-A section of 100 mm under the nozzle shown in FIG. 8A. The flow rate distributions of fuel sprays FA and FB is almost symmetry as shown in FIG. 8B.

When the flow rate distribution is divided equally into 20 regions and the flow rate is integrated in the Y direction every region divided, the points that the very inside of the fuel sprays FA, FB are assumed to be first points P1, the points of the outside of the fuel sprays FA, FB are assumed to be second points P2, and the points in the middle of the first points P1 and the second points P2 are assumed to be third points P3. The X-coordinate indicative of the peak of integrated value of the fuel flow rate exists between said first points P1 and said third points P3. The integrated value of the flow rate decreases with getting away from said peak position. The flow rate of the third point P3 from first point P1 is 1.5 times or more as much as the flow rate of the third point P3 from the second point P2.

This embodiment gives the same operation and effects as the first embodiment.

The nozzle 21 of fuel injector 20 shown in FIG. 3 and FIG. 4 can be used as a nozzle in the second embodiment though it is described as the nozzle used in the first embodiment.

Further, the nozzle 21 of fuel injector 20 shown in FIG. 6 and FIG. 7 can be used as a nozzle in the first embodiment though it is described as the nozzle used in the second embodiment.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A fuel injector arranged in the intake pipe of a port injection type internal combustion engine, which the fuel is injected from the injection port in two directions, wherein the flow rate distribution of the fuel injected from the injection port which passes the section at a specific position of the downstream from the injection port of said fuel injector has the characteristic that when the point that the periphery of the fuel spray close to the centralaxis of the injection port intersects with straight line L that connects respective gravities of the fuel sprays injected in two directions is assumed to be first point P1, the point that the periphery of the fuel spray far from the central axis intersects with said straight line L is assumed to be second point P2, and the point in the middle of the first point P1 and the second point P2 is assumed to be third point P3, the peak position of flow rate on said straight line L exists between said first point P1 and said third point P3, and the flow rate decreases with getting away from said peak position on said straight line L.

2. A fuel injector according to claim 1, wherein the specific position of the downstream from said injection port is at downstream 100 mm of said injection port.

3. A fuel injector according to claim 1 or 2, wherein the flow rate distribution of the fuel spray injected in said two directions is almost symmetry, and integral value of the flow rate of said third point P3 from said first point P1 is 1.5 times or more as much as integral value of the flow rate of said third point P3 from said second point P2.

4. A fuel injector arranged in the intake pipe of a port injection type internal combustion engine, which the fuel is injected from the injection port in two directions, wherein when the flow rate distribution of the fuel spray which passes the section at a specific position of the downstream from said injection port is divided into a plurality of regions in a direction which extends from the inside of the fuel spray injected in two directions to the outside, the flow rate of each region in a direction perpendicular to said direction is integrated, and when the point inside of the fuel spray is assumed to be first point P1, the point outside of the fuel spray is assumed to be second point P2 and the point in the middle of said first point P1 and said second point P2 is assumed to be third point P3, the peak position of said flow rate integral value exists between said first point P1 and said third point P3 and the flow rate integral value decreases as the position gets away from the peak position.

5. A fuel injector according to claim 4, wherein the specific position of the downstream from said injection port is at downstream 100 mm of said injection port.

6. A fuel injector according to claim 4 or 5, wherein the flow rate distribution of the fuel spray injected in said two directions is almost symmetry, and integral value of the flow rate of said third point P3 from said first point P1 is 1.5 times or more as much as integral value of the flow rate of said third point P3 from said second point P2.

7. A fuel injector arranged in the intake pipe of a port injection type internal combustion engine, which the fuel is injected from the injection port in two directions, wherein said injection port is terebrated in an axial direction inclined with respect to a center axis of said fuel injector, and when the center axis is assumed to be Z axis, the direction where the fuel spray of two directions extends is assumed to be X axis and the axis perpendicular to an X-Y plane is assumed to be Y axis, the tilt angle θ of said injection port becomes large and the diameter of said injection port becomes small as the distance S from a Y-Z plane increases.

8. A fuel injector arranged in the intake pipe of a port injection type internal combustion engine, which the fuel is injected from the injection port in two directions, wherein said injection port is terebrated in an axial direction inclined with respect to a center axis of said fuel injector, and when the center axis is assumed to be Z axis, the direction where the fuel spray of two directions extends is assumed to be X axis, and the axis perpendicular to an X-Y plane is assumed to be Y axis, the tilt angle θ of said injection port becomes large and the number of said injection port becomes small as the distance S from a Y-Z plane increases.
